(19) United States
(12) Patent Application Publication
(10) Pub. No.: US 2021/0321079 A1
(43) Pub. Date: Oct. 14, 2021

(54) STEREO CAMERA AND ELECTRIC MOBILITY VEHICLE

(71) Applicant: WHILL, Inc., Tokyo (JP)

(72) Inventor: Seiya Shimizu, Tokyo (JP)

(21) Appl. No.: 17/355,862

(22) Filed: Jun. 23, 2021

Related U.S. Application Data
(63) Continuation of application No. PCT/JP2019/050587, filed on Dec. 24, 2019.

(30) Foreign Application Priority Data
Dec. 26, 2018 (JP) 2018-241972

(51) Int. Cl. H04N 13/246; G06T 7/593; G06T 7/80

(52) U.S. Cl. CPC H04N 13/246; G06T 7/593; H04N 2013/0081; G06T 2207/10012; G06T 7/85

(57) ABSTRACT

A stereo camera including a pair of lens units, an imaging sensor which obtains a pair of images via the pair of lens units, a distance calculation unit which calculates distances of a plurality of positions within a detection area, which is an area where the pair of images are overlapped, based on the pair of images, and a distance correction unit which applies correction to the calculated distances of the plurality of positions, wherein the correction corresponds to positions in an arrangement direction of the pair of lens units, the correction is ne by which the closer the position comes close to an end portion in the arrangement direction within the detection area, the larger a reduction amount of the calculated distances by the correction becomes.

### CROSS-REFERENCE TO RELATED APPLICATIONS

This is a continuation of International Application PCT/JP2019/050587, claiming priority to Japanese patent application No. 2018-241972 filed on Dec. 26, 2018, with an international filing date of Dec. 24, 2019, which is hereby incorporated by reference herein in their entirety.

### TECHNICAL FIELD

This invention relates to a stereo camera and an electric mobility vehicle.

### BACKGROUND ART

Conventionally, technology in which stereo images are obtained by a stereo camera and distance of an object is calculated from the stereo images is known (see PTL 1, for example). In right images and left images which compose the stereo images, distortion which is caused by optical characteristics and manufacturing error of each of lenses of a pair of cameras and the like occurs. In PTLs 1 and 2, the distortion occurred both in the right images and in the left images are corrected, and the corrected right images and the left images are used when calculating distance.

### CITATION LIST

### Patent Literature

{PTL 1} Japanese Unexamined Patent Application, Publication No. 2011-022072
{PTL 2} Japanese Unexamined Patent Application, Publication No. 2008-298589

### SUMMARY OF INVENTION

A first aspect is a stereo camera including: a pair of lens units; an imaging sensor obtaining a pair of images via the pair of lens units; a distance calculation unit which calculates distances of a plurality of positions within a detection area, which is an area where the pair of images are overlapped with each other, based on the pair of images; and a distance correction unit which applies correction to the calculated distances of the plurality of the positions, which are calculated by the distance calculation unit, wherein the correction corresponds to positions in an arrangement direction of the pair of lens units within the detection area, wherein the correction is one by which the closer the position comes close to an end portion in the arrangement direction within the detection area, the larger a reduction amount of the calculated distances by the correction becomes.

### BRIEF DESCRIPTION OF DRAWINGS

FIG. 1 is a block diagram showing an overall configuration of a stereo camera according to a first embodiment of the present invention.

FIG. 2 is a diagram explaining a parameter with regard to the stereo camera.

FIG. 3 is a diagram explaining difference between a parallax of two positions whose X direction angles (azimuth angles) are different.

FIG. 4 is a diagram showing one example of a correction

FIG. 5A is a diagram showing a model composed by a point group.

FIG. 5B is a diagram showing a model recomposed on the basis of distance calculated from the point group.

FIG. 5C is a diagram showing a model recomposed on the basis of the distance corrected by using correction data.

FIG. 6 is a front side perspective view of an electric mobility vehicle according to the first embodiment.

FIG. 7 is a rear side perspective view of the electric mobility vehicle of the embodiment.

FIG. 8 is a plan view of the electric mobility vehicle of the embodiment.

FIG. 9 is a bottom surface view of a mobility main body in a state where some of parts are detached from the electric mobility vehicle of the embodiment.

FIG. 10 is a diagram which is seen from an inside in a width direction of a front wheel of the electric mobility of the embodiment.

FIG. 11 is a plan view of the front wheel, a suspension, and the like of the electric mobility vehicle of the embodiment.

FIG. 12 is a block diagram of a control unit of the electric mobility vehicle of the embodiment.

FIG. 13 is a side surface view of the electric mobility of the embodiment.

FIG. 14 is a plan view of a main part of the electric mobility of the embodiment.

FIG. 15 is a front view of a main part of the electric mobility vehicle of the embodiment.

FIG. 16 is a side surface view of the electric mobility vehicle of the embodiment.

### DESCRIPTION OF EMBODIMENTS

A stereo camera 1, and an electric mobility vehicle 100 having the stereo camera 1 according to a first embodiment of the present invention will be described below with reference to the accompanying drawings.

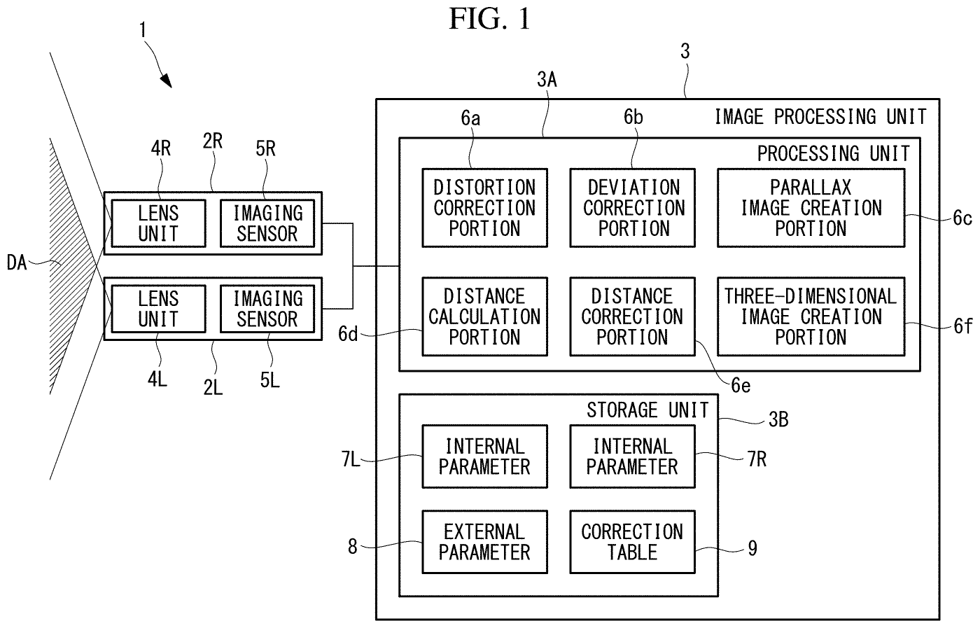

As shown in FIG. 1, the stereo camera 1 according to this embodiment include a pair of cameras 2R, 2L, and an image processor 3 which processes a pair of images obtained by the pair of cameras 2R, 2L.

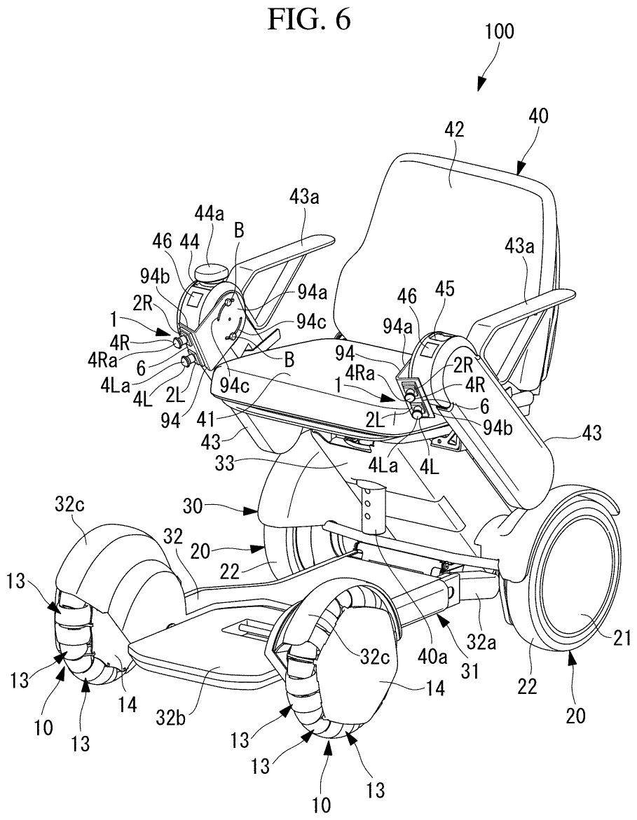

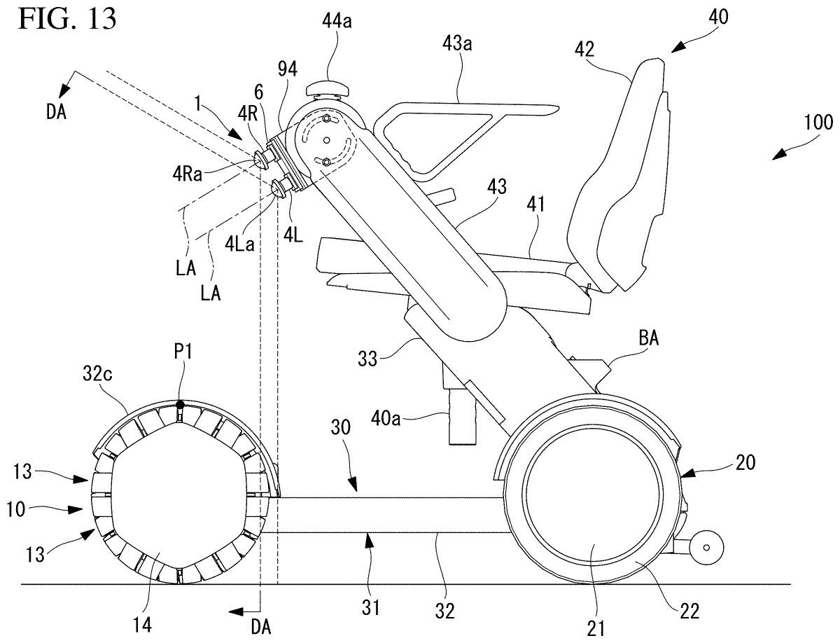

One of the cameras 2R includes a lens unit 4R, and an imaging sensor 5R which obtains images in a field of view of the lens unit 4R (right side images) via the lens unit 4R. The other one of the cameras 2L includes a lens unit 4L, and an imaging sensor 5L which obtains images in a field of view of the lens unit 4L (left side images) via the lens unit 4L. The pair of lens units 4R, 4L are supported by a camera main body 6 (refer to FIGS. 6 and 13), and the imaging sensors 5R, 5L are provided within the camera main body 6. The imaging sensors 5R, 5L are a known sensor, such as a CMOS image sensor and the like. Each of the imaging sensors 5R, 5L are connected to the image processor 3.

Light axes LA of the pair of lens units 4R, 4L are parallel or approximately parallel to each other. The lens units 4R, 4L are a wide angle lens, such as a fisheye lens. It is preferable that an angle of a field of view (a total angle of view) of each of the cameras 2R, 2L is more than 140 degrees, more than 160 degrees is more preferable, and more than 180 degrees is even more preferable.

In the following description, an XYZ rectangular coordinate system is used. The X direction corresponds to the arrangement direction of the lens units 4R, 4L, and the Z direction is parallel to the light axes LA of the lens units 4R, 4L, and the Y direction is orthogonal to the X direction and the Z direction.

The stereo cameras 1 obtain a pair of images having parallax by means of the pair of imaging sensors 5R, 5L. For explanatory convenience, a lateral direction of each of the pair of images corresponds to the X direction, and a vertical direction of each of the pair of images corresponds to the Y direction. In imaging areas of the pair of imaging sensors 5R, 5L, an area where the imaging area of the imaging sensor 5R and that of the imaging sensor 5L are overlapped with each other is a detection area DA where distance d can be calculated from the pair of images.

The stereo cameras 1 may be configured so that the pair of images are obtained by means of a single imaging sensor. For example, an image may be formed by means of one of the lens units 4R at one side of an imaging area of the single imaging sensor, and an image may be formed by means of the other one of the lens units 4L at the other side of the imaging area of the single imaging sensor.

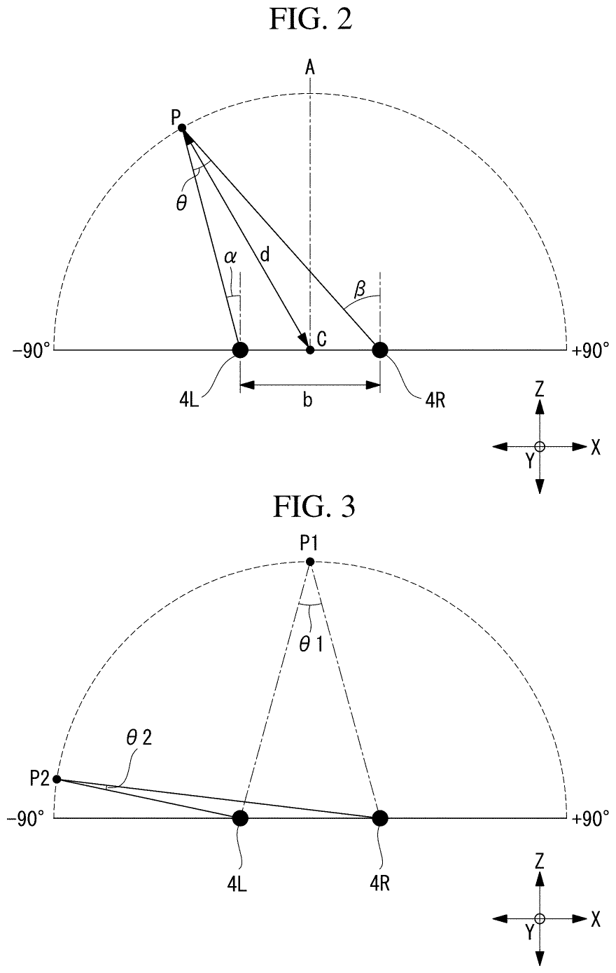

FIG. 2 explains parameters related to the stereo cameras 1. A base length b is distance between the light axes LA of the cameras 2R, 2L (lens units 4R, 4L). The distance d is distance from a camera center C to a position P within the detection area DA. The camera center C is a center position located between the pair of lens units 4R, 4L. Parallax value θ is difference between the directions at position P when seeing from the pair of lens units 4R, 4L. An X direction angle (an azimuth angle) α is an angle with respect to the light axis LA in the X direction when the position P is seen from the lens unit 4L. An X direction angle (an azimuth angle) β is an angle with respect to the light axis LA in the X direction when the position P is seen from the lens unit 4L. The light axis LA is a light axis of the stereo camera 1 which passes through the camera center C. The light axis LA of the stereo camera 1 may be the light axis of one of the cameras 2R, 2L. Relationship of θ=|α−β| is formed between the parallax values θ and the X direction angles α, β. Y direction angle (an elevation angle) γ is an angle in the Y direction when the position P is seen from the lens units 4R, 4L.

As shown in FIG. 1, the image processor 3 includes a processing unit 3A having at least a processor like a CPU (Central Processing Unit), and a storage unit 3B having a RAM, a ROM, a non-volatile memory, and the like.

The processing unit 3A includes a distortion correction portion 6a which corrects distortion in each of the pair of images, a deviation correction portion 6b which corrects deviation between the pair of images whose distortion has been corrected, a parallax image creation portion 6c which creates parallax images from the pair of images whose distortion and deviation have been corrected, a distance calculation portion 6d which calculates the distances d from the parallax images, a distance correction portion 6e which corrects the distances d, and a three-dimensional image creation portion 6f which creates point group data (three-dimensional images) on the basis of the corrected distances d′. Functions of each of the portions 6a, 6b, 6c, 6d, 6e, 6f, which will be described below, are achieved by executing processing by the processor of the processing unit 3A in accordance with an image processing program (not shown) which is stored in the storage unit 3B.

Internal parameters 7R, 7L and an external parameter 8 of the stereo camera 1 are stored in the storage unit 3B beforehand.

The internal parameter 7R is a parameter in connection with optical characteristics peculiar to the camera 2R, for example, the internal parameter 7R is expressed as a matrix or a function, and preforms correction with regard to an optical center, a focal distance, lens distortion, and the like of the camera 2R. The internal parameter 7L is a parameter in connection with optical characteristics peculiar to the camera 2L, for example, the internal parameter 7L is expressed as a matrix or a function, and performs correction with regard to an optical center, a focal distance, lens distortion, and the like of the camera 2L.

The external parameter 8 is a parameter for correcting a relative position and relative posture of the pair of cameras 2R, 2L, for example, the external parameter 8 is expressed as a rotation matrix and a translation matrix.

For example, the internal parameters 7R, 7L and the external parameter 8 are calculated by a known camera calibration using a board having a lattice pattern like a chess board is drawn.

Also, a correction table 9 for correcting errors in the distances d is stored in the storage unit 3B beforehand. In the correction table 9, a correction coefficient corresponds to each of combinations of the X direction angles (azimuth angles) α and the X direction angles (azimuth angles) β. Also, for example, one of the X direction angles (azimuth angles) α among the X direction angles α, β may correspond to the correction coefficients.

As shown in FIG. 3, two positions P1, P2, whose distances d are equal to each other, will be considered. The position P1 is located at the center of the detection area DA in the X direction (in front of the camera center C). The position P2 is located closer to an edge of the detection area DA than the position P1 in the X direction. In the example of FIG. 3, an angle of field of view of each of the cameras 2R, 2L is 180 degrees (−90 degrees to +90 degrees). That is to say, the detection area (angle range) DA which is seen from the stereo camera 1 is also about 180 degrees. In the case of the stereo cameras 1 for the electric mobility vehicle 100, it is sufficient that the angle of field of view is more than 140 degrees (−70 degrees to +70 degrees), and more than 160 degrees (−80 degrees to +80 degrees) is more preferable. Parallax θ2 of the position P2 is smaller in comparison with the parallax θ1 of the position P1. A ratio of the parallax θ2 with respect to the parallax θ1 is uniquely determined by the base length b, the X direction angles α, β, and the Y direction angle γ of the position P2. This ratio is the correction coefficient. Therefore, the correction coefficient is a value larger than 0 and equal to or smaller than 1.

The correction table 9 is determined on the basis of optical design (base length b) of the stereo camera 1. Therefore, it is possible to use the same correction table 9 for the stereo cameras 1 having the same optical design (base line b).

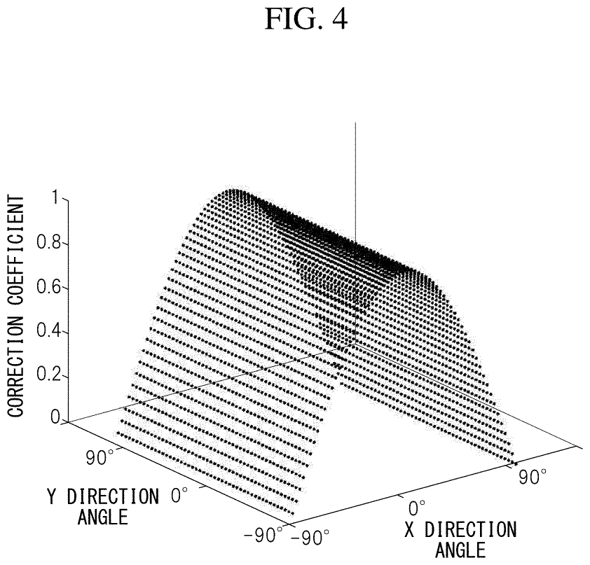

FIG. 4 shows one example of the correction coefficient. In FIG. 4, each of points represents correction coefficients. As shown in FIG. 4, as the X direction angles α, β get closer to the limit (±90 degrees) of the angle of the field of view, the correction coefficients decrease. For example, within the detection area DA, in an area where the X direction angle α, which is the angle of the field of view, is closer to ±90 degrees, the correction coefficients decrease. In this example, the correction coefficients change depending only on the X direction angles α, β among the X direction angles α, β and the Y direction angle γ.

Note that, the correction coefficients may change depending not only on the X direction angles α, β, but also on the Y direction angle γ.

In one example, in a range where magnitude (an absolute value) of at least one of the X direction angles (azimuth angles) α, β are larger than 75 degrees, the correction coefficients are smaller than 0.3. And, in a range where the magnitude (absolute value) of at least one of the X direction angles (azimuth angles) α, β are larger than 70 degrees, the correction coefficients are smaller than 0.4. Also, in a range where the magnitude (absolute value) of at least one of the X direction angles α, β are larger than 65 degrees, the correction coefficients are smaller than 0.6.

The distortion correction portion 6a receives the right images from the imaging sensor 5R, and receives left images from the imaging sensor 5L. In the right images, distortion which is caused by the lens distortion of the camera 2R and the like occurs. In the left images, distortion which is caused by the lens distortion of the camera 2L and the like occurs. The distortion correction portion 6a corrects the distortion in the right images on the basis of the internal parameter 7R of the camera 2R, and the distortion in the left images on the basis of the internal parameter 7L of the camera 2L.

The relative position and the relative posture between the cameras 2R, 2L are deviated from designed value due to manufacturing error and the like. Deviation due to physical (geometrical) deviation between the cameras 2R, 2L, occurs between the right images and the left images. The deviation correction portion 6b corrects the deviation between the right images and the left images on the basis of the external parameter 8. For example, the deviation correction portion 6b rotates and translates one of the right images and the left images on the basis of the external parameter 8.

The parallax image creation portion 6c calculates the parallax θ of each of the positions within the detection area DA from the right images and the left images whose distortion and deviation have been corrected, and creates parallax images, and then each of the pixels have information of the parallax θ.

For example, in such a case where the parallax images are created on the basis of the left images, the parallax image creation portion 6c sets one image among the left images as a noticeable pixels, and detects pixels of a right image corresponding to the noticeable pixels by stereo matching, so as to calculate deviation amount (a number of pixel value) in the X direction between the noticeable pixels and the corresponding pixels. In the left image, positions of the pixels in the X direction correspond to the X direction angle α. In the right image, positions of the pixels in the X direction correspond to the X direction angle R. Therefore, the deviated amount in the X direction corresponds to the parallax θ. The parallax image creation portion 6c gives the deviated amount in the X direction to the noticeable pixels of the left images. The parallax image creation portion 6c sets all the pixels within the detection area of the left images as the noticeable pixels in a sequence, and repeats the same process so as to create the parallax images.

The distance calculation portion 6d calculates the distances d from the parallax values θ of the pixels of the parallax images and the base length b. For example, the distance calculation portion 6d calculates the distance d from the following formula (1).

d=b/θ (1)

The distance correction portion 6e corrects the distance (calculated distance) d of each of the pixels calculated by the distance calculation portion 6d by using the correction data.

More specifically, for example, the distance correction portion 6e selects a correction coefficient corresponding to the X direction angle (azimuth angle) α of each of the pixels of the parallax image from the correction table 9. In the correction table 9, in such a case where a correction coefficient corresponds to the Y direction angle (azimuth angle) γ, the distance correction portion 6e selects a correction coefficient which corresponds to the X direction angle (azimuth angle) α and the Y direction angle (azimuth angle) γ of each of the pixels from the correction table 9. Next, the distance correction portion 6e obtains the corrected distance d′ by multiplying the selected correction coefficient to the distance d. As described above, the correction coefficients are the values larger than 0 and equal to or smaller than 1. Accordingly, the distance correction portion 6e corrects the distances d so that the distances d becomes smaller, and the corrected distances d′ are smaller than the distances d before the correction. The closer the X direction angles α, β get to a limit of the angle of the field of view, the smaller the correction coefficients become, and, the larger reduction amounts of the distances d′ with respect to the distances d become.

The three-dimensional image creation portion 6f creates the point group data (point group image) on the basis of the positions of the pixels of the parallax image in the X direction and the Y direction, and the corrected distances d′ thereof. The point group data is data including the three-dimensional coordinate of each of the points corresponding to each of the pixels within the detection area DA. The point group images can be created by mapping the points in the point group data to a three-dimensional coordinate space. The three-dimensional image creation portion 6f may create the distance image data whose pixels have the information of the distances d′, instead of or in addition to the point data.

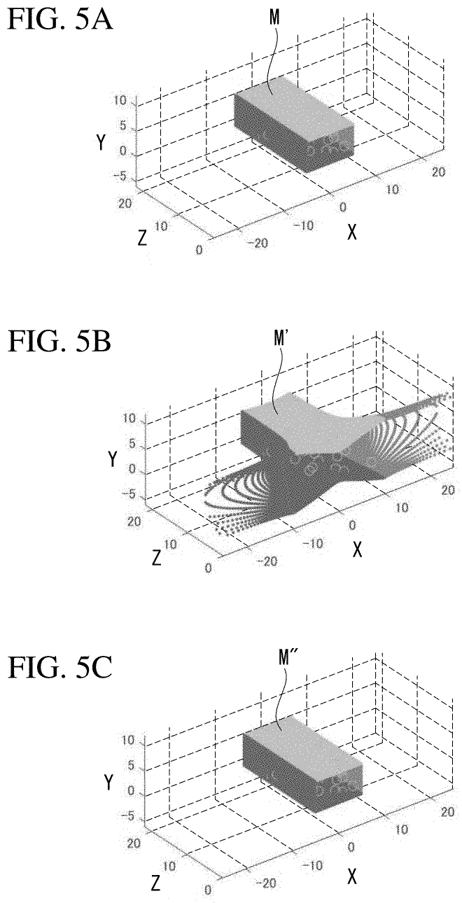

FIGS. 5(a) to (c) show a simulation result of the image processing by the image processing unit 3.

FIG. 5(a) shows a model M, which is composed by the point group, and which is in a rectangular parallelepiped shape.

The parallax values θ are calculated on the basis of coordinates of the points of the model M, and the distances d are calculated from the parallax values θ.

FIG. 5(b) is the point group image of a Model M′ which is recomposed on the basis of the distances d. In FIG. 5(b), in a center portion where the X direction angles α, β are close to 0 degree, the model M′ has a shape which is the same as or similar to that of the model M. On the other hand, in a portion where the X direction angles α, β are close to the limit of the angle of the field of view, the distances d which are calculated from the parallax values θ are larger than the actual distances, therefore, the model M seems largely deformed and diverged toward the X direction. It means that, in this area, in fact, an object existing at a position close to the stereo camera 1 is recognized as an object existing at a position distant from the stereo camera 1 on the point group images.

FIG. 5(c) is a point group image of a model M″ which is recomposed on the basis of the corrected distances d′. In FIG. 5(c), in an entire range of the wide angle of the field of view (−90 degrees to +90 degrees), the model M″ accurately reproduces the shape of the model M.

As described above, an error depending on the X direction angles α, β and the Y direction angle γ occurs to the distances d which are calculated from the parallax values θ of the pair of images. A dominant factor causing the error is the X direction angles α, β, which is obvious from FIG. 5(b). According to this embodiment, the distance d is corrected so as to be the distance d′ by means of the correction table 9, and the closer the X direction angles α, β get to the limit of the angle of the field of view (that is to say, the closer the position gets to the end portion of the detection area DA in the X direction), the larger the reduction amount of the distance d′ with respect to the distance d becomes. By this, it is possible to correct the error of the distance d which depends on the X direction angels α, β so that the accurate distance d′ can be calculated.

The error depending on the Y direction angle γ may occur to the distances d which are calculated from the parallax values θ of the pair of images. Therefore, as shown in FIGS. 5(a) to (c), in such a case where the correction table 9, in which the correction coefficients change in the Y direction angle γ, is changed, an error of the distances d changed depending on the Y direction angle γ is corrected, and more accurate distances d′ can be calculated.

As you can see from the formula (1), for example, as the X direction angle (azimuth angle) α gets closer to the limit of the angle of the field of view, that is to say, as the X direction angle (an azimuth angle) α gets closer to the limit of the detection area DA, an error between the distances d calculated from the parallax values θ and the actual distance becomes larger at a larger increase rate. Accordingly, as shown in FIGS. 5(a), (b), it is preferable that the correction coefficients in the correction table 9 decrease at a larger reduction rate as the X direction angle (an azimuth angle) α gets closer to the limit of the detection area DA.

With the above described correction coefficients, the error in the distances d can be corrected more accurately, which is capable of obtaining the more accurate distances d′.

In this embodiment, the distance correction portion 6e corrects the distances d of all the positions within the detection area DA, however, instead of this, only the distances d of positions in a predetermined area within the detection area DA may be corrected.

The predetermined area is an area located at the both ends of the detection area DA in the X direction, where the error in the distances d depending on the X direction angles α, β become larger. For example, the predetermined area is an area where magnitude (an absolute value) of at least one of the X direction angles α, β is more than 60 degrees.

In this embodiment, the distance correction portion 6e corrects the distances d by means of the correction table 9, however, instead of this, the corrected distances d′ may be calculated from the base length b and the X direction angles α, β.

For example, the distance correction portion 6e may calculate the corrected distances d′ by a predetermined function using the base length b, the X direction angles α, β, and the Y direction angle γ as a variable. The predetermined function is designed so that the reduction amount of the distances d′ with respect to the distances d becomes larger as the X direction angles α, β get closer to the limit of the angle of the field of view. The above described predetermined function is determined experimentally or by simulation, for example.

An electric mobility vehicle 100 according to an embodiment of the present invention will be described below with reference to the accompanying drawings.

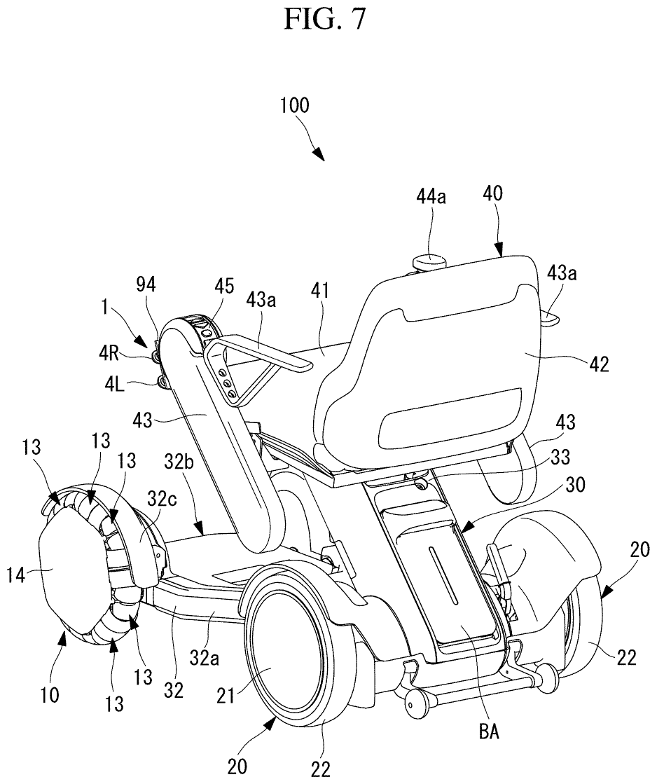

As shown in FIGS. 6 to 9, this electric mobility vehicle 100 includes a pair of front wheels 10, a pair of rear wheels 20, and a mobility body 30 which is supported by the front wheels (wheels) 10 and the rear wheels (wheels) 20. For example, the mobility body 30 has a body 31 which is supported by the front wheels 10 and the rear wheels 20, a seat unit 40 which is attached to the body 31, and motors 50 which are attached to the mobility body 30, and which drive at least one of the pair of front wheels 10 or the pair of rear wheels 20. In this embodiment, the motors 50 are attached to the body 31, and the seat unit 40 is removable from the body 31. This electric mobility vehicle 100 is a vehicle on which one person can sit to ride the vehicle.

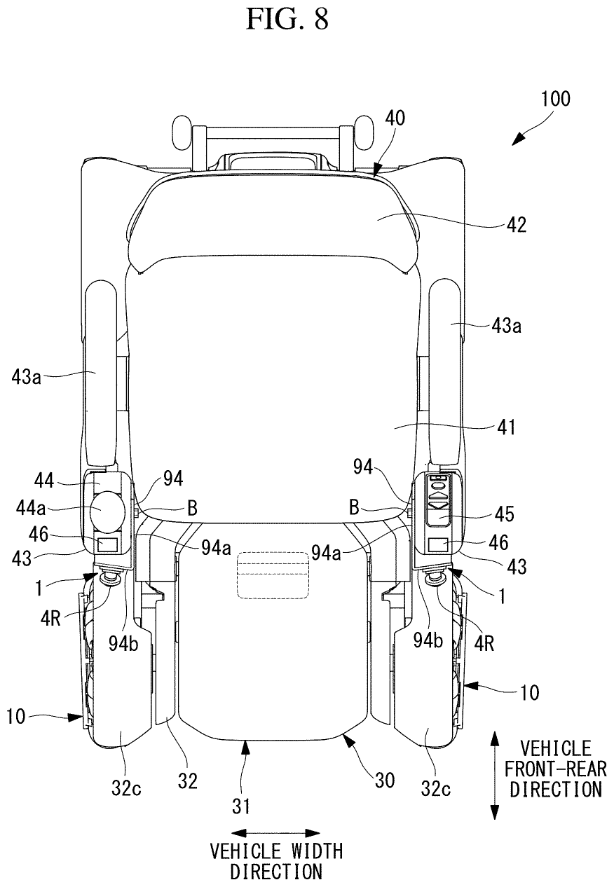

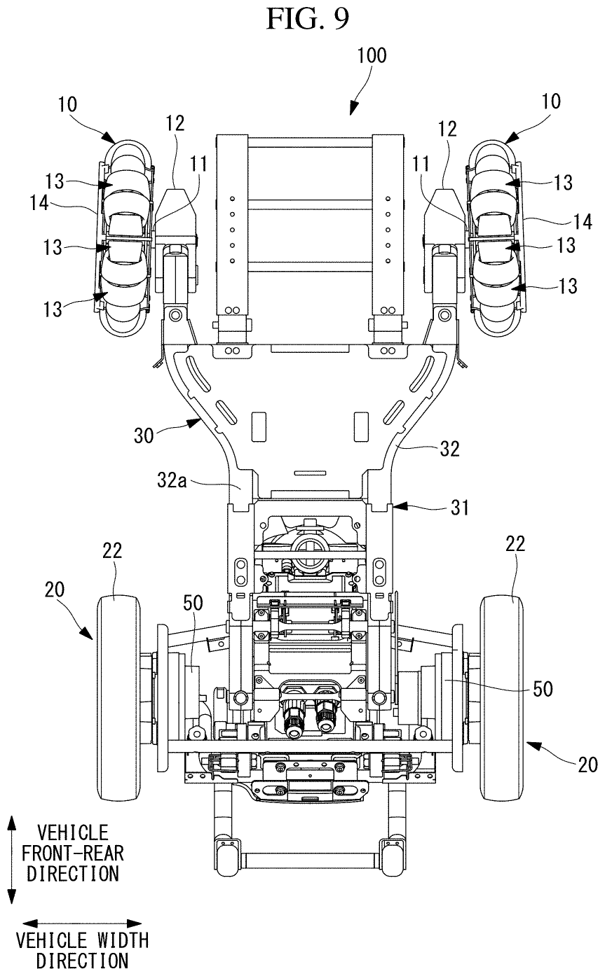

A vehicle front-rear direction shown in FIGS. 8 and 9 may be referred to as a front-rear direction in the following description, and a vehicle width direction shown in FIGS. 8 and 9 may be referred to as a width direction or left-right direction in the following description. Note that, the vehicle front-rear direction and the front-rear direction of the mobility body 30 are identical with each other, and the vehicle width direction and the width direction of the mobility body 30 are identical with each other. In this embodiment, the radial centers of the pair of front wheels 10 are arranged in the vehicle width direction, and the radial centers of the pair of rear wheels 20 are also arranged in the vehicle width direction, and also the vehicle front-rear direction is orthogonal to the vehicle width direction.

In this embodiment, the pair of rear wheels 20 are respectively connected to the motors 50, and each of the motors 50 drives corresponding rear wheels 20. Driving force of the motors 50 is transmitted to the corresponding front wheels 10 via a driving force transmitting means. The driving force transmitting means is a belt, gear, or the like.

As shown in FIGS. 9 to 11, the front wheels 10 are supported by the body 31 by means of axles 11 and suspensions 12. Also, a contact surface of the front wheels 10 is formed by a plurality of rollers 13 which are arranged in a circumferential direction of the front wheels 10.

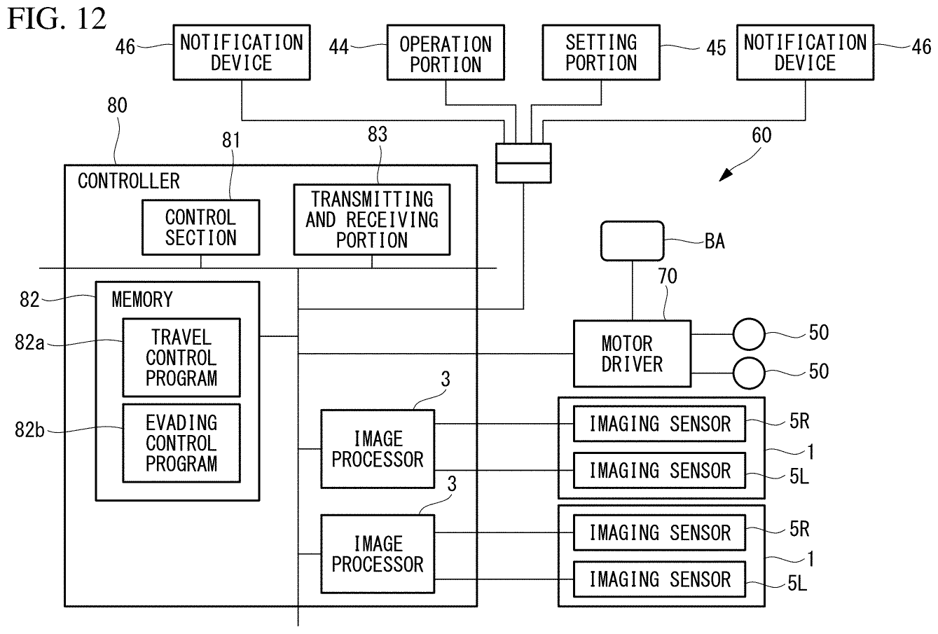

Each of the suspensions 12 has a support member 12a and a springy member 12b which is a coil spring or the like. One end side of the support member 12a is supported by a front end side of the body 31, and the support member 12a can swing around a first axis line A1 extending in the vehicle width direction. The springy member 12b biases the other end side of the support member 12a toward the vehicle front direction. The axles 11 of the front wheels 10 are fixed to the support members 12a. Also, as shown in FIG. 11, a second axis line A2, which is a central axis line of the axle 11, is inclined toward the front direction with respect to a horizontal line HL, which is perpendicular to the front-rear direction. In a plan view, it is preferable that an angle a which is between the second axis line A2 and the horizontal line HL is 2 degrees to 15 degrees, however, the angle α may be any other angle depending on conditions.

In this embodiment, the other end of the support member 12a is movable toward the vehicle rear side with respect to the body 31 against the biasing force of the springy members 12b. Therefore, it is possible to effectively reduce vibration which is generated by collision of the rollers 13 with the contact surface. Note that, the front wheels 10 may not arranged in the toe-in state. Reducing the vibration is advantageous to improve the accuracy in detecting the object by the stereo camera 1.

Each of the front wheels 10 includes a hub 14 which is attached to the axles 11, and a plurality of roller supporting shafts (not shown) which are supported by the hub 14, and the plurality of rollers 13 are supported respectively by the roller supporting shafts in a rotatable manner. Note that, the hub 14 may be attached to the axles 11 by means of a bearing or the like, and the hub 14 may be attached to the axles 11 by means of a cushioning member, an intermediate member, or the like. Axis lines of the roller supporting shafts extend in directions orthogonal to the radial direction of the axle 11.

The rollers 13 rotate around the axis line of the corresponding roller support shafts. That is to say, the front wheels 10 are omnidirectional wheels which move in every direction with respect to a travel surface.

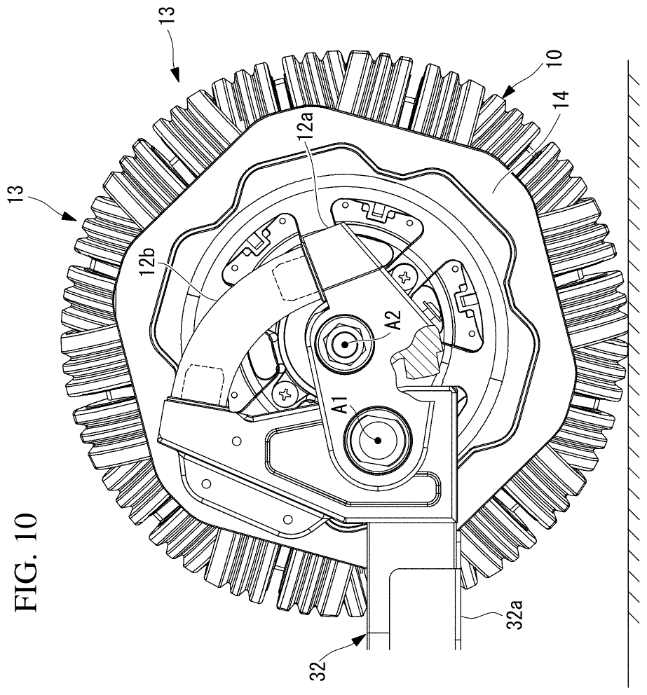

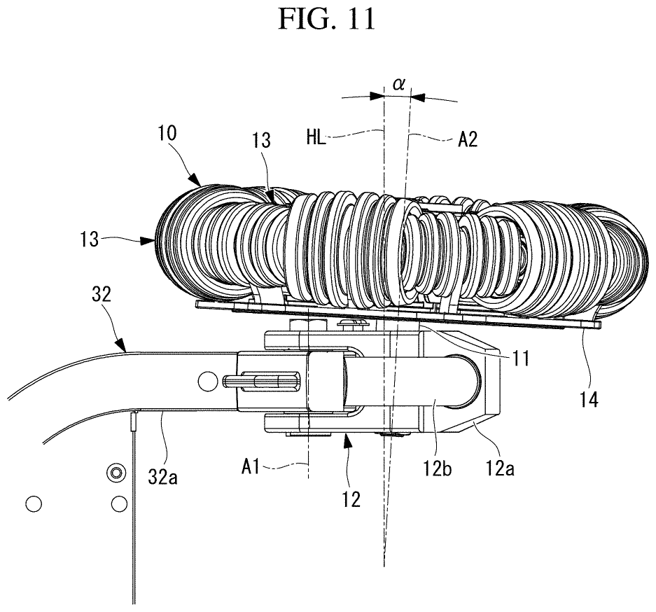

An outer circumferential surface of the roller 13 is formed by using a material having rubber-like elasticity, and a plurality of grooves extending in the circumferential direction thereof are provided on the outer circumferential surface of the roller 13 (refer to FIGS. 10 and 11).

In this embodiment, the rear wheels 20 include an axle which is not shown, a hub 21 attached to the axle, and an outer circumferential member 22 which is provided on the outer circumferential side of the hub 21, and the outer circumferential surface thereof is formed by using a material having rubber-like elasticity, however, the omnidirectional wheels may be used as the rear wheels 20, which are the same as the front wheels 10. The axle of the rear wheels 20 may be the same with a main shaft of the motor 50.

Structure of the body 31 is changeable as required. In this embodiment, the body 31 includes a base portion 32 which extends along the ground, and a seat support portion 33 which extends toward an upper side from a rear end side of the base portion 32. The seat support portion 33 is inclined toward the vehicle front side, and a seat unit 40 is attached to the upper end side of the seat support portion 33.

The base portion 32 of this embodiment includes a metallic base frame 32a which supports the suspensions 12 of the front wheels 10 and the motors 50 of the rear wheels 20, and a plastic cover portion 32b which at least partially covers the base frame 32a. The cover portion 32b is used as a portion for putting feet of a driver seated on the seat unit 40, a portion for placing a luggage, or the like. The cover portion 32b also includes a pair of fenders 32c each of which covers the corresponding front wheels 10 from the upper side. In one example, the fenders 32c only have a function which covers the front wheels 10. In another example, the fenders 32c also have a function which strengthens rigidity of the body 31. Also, there may be a case where each of the fenders 32c cover only a part of the front wheels 10.

In this embodiment, the seat unit 40 has a shaft 40a at the lower portion thereof, and the shaft 40a is attached to the upper end side of the seat support portion 33. A rechargeable battery BA is provided at the back surface of the seat support portion 33, and a control unit 60, which will be described below, is placed within the seat support portion 33.

The seat unit 40 has a seat surface portion 41 on which a driver is seated, a backrest portion 42, a right control arm 43, and a left control arm 43.

An armrest 43a is fixed to the upper surface of each of the control arms 43. For example, the driver puts the arms on the armrests 43a of the pair of the control arms 43, respectively. Also, the driver puts the arms on the upper ends of the pair of control arms 43, respectively. In this embodiment, both of the control arms 43 and the armrests 43a are provided, however, the control arms 43 or the armrests 43a may only be provided. In this case, the driver puts at least one of the arms and the hands on the control arms 43, or puts at least one of the arms and the hands on the armrests 43a.

An operation portion 44 having an operation lever 44a is provided at the upper end of the right control arm 43. In such a state where no force is applied, the operation lever 44a is positioned at a neutral position by a springy member (not shown) which is located within the operation portion 44. The driver can displace the operation lever 44a toward the right direction, the left direction, the front direction, and the rear direction with respect to the neutral position.

A signal, which is in response to displacement direction and displacement amount of the operation lever 44a, is sent from the operation portion 44 to the control unit 60, which will be described below, and the control unit 60 controls the motors 50 in response to the received signal. For example, when the operation lever 44a is displaced toward the front direction with respect to the neutral position, a signal which makes the motors 50 rotate toward the vehicle front side is sent. By this, the electric mobility vehicle moves forward at speed which is in response to the displacement amount of the operation lever 44a. Also, when the operation lever 44a is displaced toward the left diagonal forward direction with respect to the neutral position, a signal which makes the left motor 50 rotate toward the vehicle front side at speed which is slower than the right motor 50. By this, the electric mobility vehicle moves forward while turning left at speed which is in response to the displacement amount of the lever 44a.

A setting portion 45 which is for performing all sorts of settings related to the electric mobility vehicle is provided at the upper end of the left control arm 43. Examples of the various sorts of settings are settings of maximum speed, settings regarding a driving mode, and settings for locking the electric mobility vehicle.

A notification device 46 is provided in each of the left and the right control arms 43. The notification device 46 is a voice generator, a display, a vibration generation device, or the like. The vibration generation device vibrates a part of the upper end side of the control arm 43, the operation portion 44, the setting portion 45, and the like, at several tens of Hz for example.

As shown in FIG. 12, the control unit 60 has a motor driver 70 which drives the motors 50, and a controller 80.

The motor driver 70 is connected to the battery BA. Also, the motor driver 70 is connected to each of the motors 50 as well, and the motor driver 70 supplies drive power to the motors 50.

As shown in FIG. 12, the controller 80 includes a control section 81 having a CPU, a RAM, and the like, a storage unit 82 having a non-volatile storage, a ROM, and the like, and a transmitting and receiving portion 83. A travel control program 82a which controls the electric mobility vehicle is stored in the storage unit 82. The control section 81 operates on the basis of the travel control program 82a. The control section 81 sends drive signals for driving the motors 50 to the motor driver 70 on the basis of the signals from the operation portion 44 and the setting portion 45.

Two stereo cameras 1 are attached to the upper end side of the right control arm 43 and the upper end side of the left control arm 43, respectively. Two image sensors 5R, 5L are respectively connected to the image processor 3 and, in this embodiment, the image processor 3 is provided in the controller 80. The image processor 3 may be provided outside the controller 80.

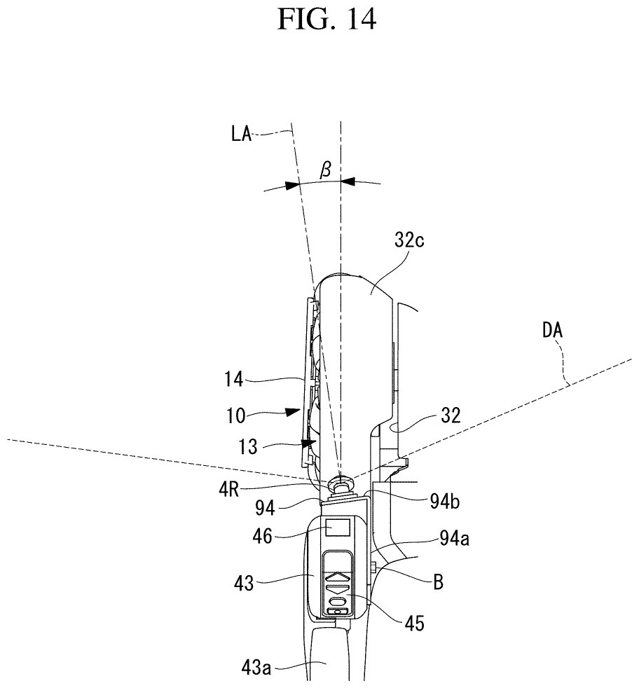

As shown in FIG. 14, in an example, at least a part of the left front wheel 10, or a part of the fender 32c of the left front wheel 10 is within a detection area DA of the stereo camera 1 provided at the left control arm 43. Also, an area at the outside in the width direction with respect to the left front wheel is within this detection area DA.

Similarly, at least a part of the right front wheel 10, or a part of the fender 32c of the right front wheel 10 is within the detection area DA of the stereo camera 1 provided at the right control arm 43. Also, an area at the outside in the width direction with respect to the right front wheel 10 is within this detection area DA.

Here, as shown in FIG. 13, for example, the detection area DA of the stereo camera 1 is an area where the image caption areas of the imaging sensors 5R, 5L are overlapped.

Also, as shown in FIG. 14, a light axis LA of each the lens units 4L, 4R of the stereo camera 1 extends diagonally toward the outside in the width direction. More specifically, in a plan view shown in FIG. 14, the light axis LA of each of the lens units 4L, 4R extends in a direction forming an angle β with respect to the front-rear direction. In one example, the angle β is 5 degrees to 30 degrees.

Also, as shown in FIGS. 6, 13, and the like, one of a tip lenses (4Ra) of the pair of lens units 4R, 4L of the stereo camera 1 is located above the other one of tip lenses (4La). That is to say, the tip lens 4Ra is located at a position higher than the tip lens 4La.

Also, as shown in FIG. 13 and the like, one of the tip lenses 4Ra is located at a front side in the vehicle front-rear direction with respect to the other tip lens 4La. That is to say, the tip lens 4Ra is located at a front side in comparison with the tip lens 4La.

Also, as shown in FIG. 13 and the like, each of the light axes LA of the pair of lens units 4R, 4L extends in a diagonally downward direction.

Also, as shown in FIGS. 8, 13 and the like, the pair of lens units 4R, 4L respectively face the vehicle front direction. When the angle β is smaller than 40 degrees, and an angle formed by the light axes LA of the lens units 4R, 4L and the horizontal direction is smaller than 40 degrees, It can be said that the pair of lens units 4R, 4L face the vehicle front direction. Note that, it is preferable that each of the above described angles is smaller than 30 degrees.

In other words, the pair of lens units 4R, 4L are arranged so as to be aligned in the vertical direction and/or vehicle front-rear direction with each other.

FIG. 14 shows a part of the detection area DA, and the detection area DA also includes an area which is located in front of the area shown in FIG. 14. As shown in FIG. 14, in this embodiment, the part of the left front wheel 10, and the part of the fender 32c of the left front wheel 10, and the travel surface at the outside in the width direction with respect to the left front wheel 10 are within the detection area DA of the left stereo camera 1. In such a case where there is an object to be avoided, such as an obstacle, a wall, a gutter, or the like is on the travel surface, the object to be avoided enters the detection area DA of the stereo cameras 1. The detection area DA of the right stereo camera 1 is the same as or the similar to the detection area DA of the left stereo camera 1.

The control section 81 of the controller 80 operates on the basis of an evading control program 82b which is stored in the storage unit 82. And, the control section 81 detects, in the point group data (point group image) made by the 3D image creation section, the object to be avoided with which the front wheels 10 or the fenders 32c may come into contact. The object to be avoided is an obstacle, a person, an animal, a plant, and the like, for example. And, the obstacle is a wall, a large rock, a bump, and the like, for example. In another example, the control section 81 detects the object to be avoided, such as a bump, a hole a gutter, or the like, in which the front wheels 10 may be fallen or get caught, in the distance images.

In FIG. 13, in the X direction angle (azimuth angle) α of the stereo camera 1, the angle of the field of view of the cameras 2R, 2L is about 140 degrees (±70 degrees). Therefore, the detection area (angle range) DA which is seen from the stereo camera 1 is also about 140 degrees.

Here, it is highly possible that an object to be avoided with which the front wheels 10 or the fenders 32c may come into contact appears in an area where the X direction angle a in the detection area DA is close to 70 degrees. For example, it is highly possible that the object to be avoided appears in an area where the X direction angle a is more than 65 degrees.

The control section 81 controls the motors 50 by control signals for evading operation, when the object to be avoided with which the wheels 10 or the fenders 32c may come into contact is detected in a predetermined area AR1 of the detection area DA, for example. In another example, the control section 81 operates the notification devices 46 in such a case where the object to be avoided with which the wheels 10 or the fenders 32c may come into contact in the predetermined area AR1 of the detection area DA, for example. Also, the control section 81 controls the motors by control signals for evading operation when the control section 81 detects the object to be avoided in which the front wheels 10 may be fallen or get caught in the predetermined area AR1 of the detection area DA, for example. In another example, the control section 81 operates the notification devices 46 when the control section 81 detects the object to be avoided in which the front wheels 10 may be fallen or get caught in the predetermined area AR1 of the detection area DA, for example. Examples of the evading operation include reduction of the rotation speed of the motors 50, stopping the rotation of the motors 50, controlling the motors 50 for restricting the movement of the electric mobility vehicle toward the side of the object to be avoided, and the like. In another example, as the evading operation, the control section 81 vibrates the upper end portion of the left and right control arms 43 by means of the notification devices 46. Furthermore, in another example, as the evading operation, the control section 81 generates an alert by means of the notification devices 46.

For example, with respect to either one of the left or the right, when the control section 81 detects that the front wheel 10 or the fender 32c may come into contact with the object to be avoided, or may be fallen or get caught in the obstacle in the predetermined area AR1 of the detection area DA, the control section 81 vibrates the upper end of the said one of the control arms 43 by means of the notification device 46. By this, the driver can intuitively recognize the direction where front wheel 10 or the fender 32c may come into contact with the object to be avoided, the wheel may be fallen or get caught in the obstacle.

Also, the evading operation may be performed when the object to be avoided is detected of the detection area DA of the

Here, the image processing unit 3 of the stereo camera 1 largely corrects the distances d which are obtained by the distance calculation portion 6d in the area where the X direction angle (azimuth angle) α is close to the limit of the field of view. Accordingly, in the area where the X direction angle (azimuth angle) α is close to the limit of the field of view, it is also possible to detect the distances accurately.

Also, in FIG. 13, in the X direction angle (azimuth angle) a of the stereo camera 1, in such a case where the angles of the field of view of the cameras 2R, 2L are about 180 degrees, it is also possible to detect the object to be avoided appears in the area located at the outside in the width direction of the rear wheels 20. There is a case where the rear wheels 20 are omnidirectional wheels, and in that case, it is especially useful to detect the object to be avoided which appears in the area located at the outside in the width direction of the rear wheels 20.

As described above, by using the configuration of this embodiment, the area located at the outside in the width direction of each of the front wheels 10 is positioned within the detection area DA of the stereo camera 1. Also, in an example, at least the part of the front wheel 10 or the part of the fender 32c of the front wheel 10 is positioned within the detection area DA of the stereo camera 1. This configuration is extremely advantageous for certainly grasping a relationship between the object to be avoided, which exists at the outside in the width direction of the front wheel 10, and the front wheel 10.

Also, when the driver checks the vicinities of the front wheels 10 on the travel surface located at the outside in the width direction of the front wheels 10 by eyesight, the driver has to change the posture. In this embodiment, the vicinities of the front wheels 10 on the travel surface located at the outside in the width direction of the front wheels 10 is positioned within the detection area DA of the stereo cameras 1, which is capable of reducing the burden of the monitoring by the driver.

Especially, when the driver drives the electric mobility vehicle in the house or the office, the driver needs to be careful not to come into contact with an object to be avoided, such as furniture, a wall, and the like. Also, the driver needs to be careful not to enter the object to be avoided, such as stairs and the like. There are various kinds of objects to be avoided in the house or the office. For that reason, it is difficult for the driver to certainly grasp all of these objects to be avoided by visual observation. Therefore, the configuration of this embodiment is extremely useful in the house and the office.

Also, the left stereo camera 1 may be attached, for example, to the seat unit 40, the body 31, a pole extending from the seat unit 40 or the body 31, the left control arm 43, the armrest 43a thereof, or the like, so that at least one of the part of the left rear wheel 20 and the part of the fender of the left rear wheel 20 is positioned within the detection area DA of the left stereo camera 1.

Also, the right stereo camera 1 may be attached, for example, to the seat unit 40, the body 31, the pole extending from the seat unit 40 or the body 31, the right control arm 43, the arm rest 43a thereof, or the like, so that at least one of the part of the right rear wheel 20 and the part of the fender of the right rear wheel 20 is positioned within the detection area DA of the right stereo camera 1.

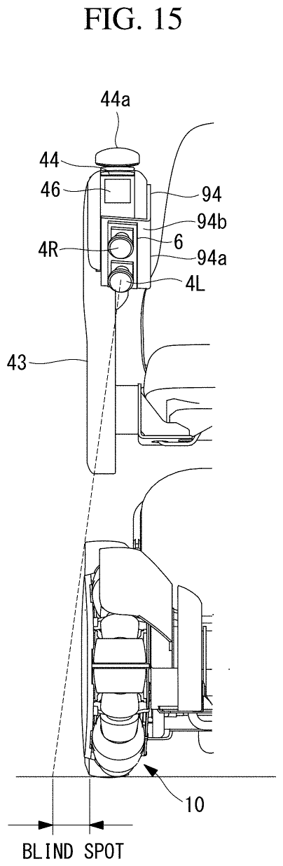

Also, as shown in FIG. 13, the pair of lens units 4R, 4L of the stereo camera 1 are not aligned in the lateral direction with each other, but are aligned in the vertical direction with each other. As described above, the detection area DA of the stereo camera 1 is an area where the imaging areas of the imaging sensors 5R, 5L are overlapped with each other. Therefore, the configuration of this embodiment, in which the pair of lens units 4R, 4L are arranged so as to be aligned in the vertical direction with each other, is advantageous for reducing or eliminating a blind spot located at the outside in the width direction of the front wheels 10, as shown in FIG. 15.

When the driver changes the direction of the electric mobility vehicle or the like, in many cases, there is not much space around the electric mobility vehicle. Further, when the driver is seated on the electric mobility vehicle and works in the desk, the front end side of the electric mobility vehicle enters under the desk. In this case, it is extremely difficult for the driver to see the vicinity of the front wheels 10 on the travel surface at the outside in the width direction of the front wheels 10. Under these circumstances, the above described configuration is extremely useful for reducing the blind spot at the outside in the width direction of the front wheels 10.

Further, the pair of lens units 4R, 4L may be arranged in the front-and-rear direction with each other, and the pair of lens units 4R, 4K may be arranged in the vertical direction and the front-rear direction with each other. These configurations are advantageous for reducing or eliminating the blind spot located at the outside in the width direction of the front wheels 10.

Also, in this embodiment, positions of the lens units 4R, 4L of each of the stereo cameras 1 in the width direction and positions of the corresponding front wheels 10 in the width direction are overlapped with each other. Moreover, in this embodiment, the positions of the lens units 4R, 4L in the width direction are existing areas of the lens units 4R, 4L in the width direction, and the positions of the front wheels 10 in the width direction are existing areas of the front wheels 10 in the width direction. As shown in FIG. 15, this configuration is advantageous for reducing the blind spot located at the outside in the width direction of the front wheels 10.

Also, in another example, the lens units 4R, 4L of each of the stereo cameras 1 are located above the travel surface at the outside in the width direction of the corresponding front wheels 10. This configuration allows further reduction of the blind spot located at the outside in the width direction of the front wheels 10, or eliminate the blind spot.

Furthermore, in this embodiment, each of the stereo cameras 1 is attached to the corresponding control arm 43. The control arms 43 are the portion where the driver puts his/her hands or arms. It is often the case that each of the control arms 43 is positioned at outside in the width direction with respect to the torso of the driver who is seated on the seat unit 40. Also, it is often the case that each of the control arms 43 is positioned at the outside in the width direction with respect to the thighs of the driver who is seated on the seat unit 40. Accordingly, this configuration reduces the possibility that the detection area DA of the stereo camera 1 is hindered by the body of the driver.

Also, instead of providing the pair of control arms 43, it is possible to provide the pair of arm rests 43a in the seat unit 40. For example, it is possible to attach the stereo cameras 1 to the front end portions of the arm rests 43a. This configuration also provides the same or the similar effects as those described in this embodiment.

Furthermore, the driver can visually confirm the positions of his/her hands and the positions of his/her arms easily. Also, even in a case where the driver is not looking at the positions of his/her own hands and the positions of his/her own arms, it is possible to instinctively recognize the approximate positions of his/her own hands and the approximate positions of his/her own arms. Therefore, the configuration of this embodiment, in which the stereo cameras 90 are provided on the control arms 43 and the arm rests 43a, is advantageous for preventing the stereo cameras 90 from having a collision with a wall and the like. That is to say, the configuration of this embodiment is advantageous for preventing the stereo cameras 1 from being damaged, or displaced, and the like.

Also, the light axis LA of each of the lens units 4L, 4R of the stereo camera 1 extends diagonally toward the outside in the width direction. Therefore, a wider area at the outside in the width direction of the front wheels 10 is positioned within the detection area DA of the stereo cameras 1. This configuration is extremely advantageous for certainly grasping the relationship between the object to be avoided, which exists at the outside in the width direction of the front wheels 10 and the front wheels 10.

In this embodiment, the pair of front wheels 10 are in a toe-in state. That is to say, in such a state where the electric mobility vehicle moves straight toward the front side, the rear end sides of the front wheels are located at the outside in the width direction in comparison with the front end sides thereof. In this embodiment, it is possible to monitor the outside in the width direction of the front wheel 10 in detail. Therefore, in such a state where the electric mobility vehicle moves straight toward the front side, it is possible to detect the object to be avoided which the front end side of the front wheel 10 does not come into contact with, but the rear end side of the front wheel 10 does. For example, at the time when the electric mobility vehicle moves straight toward the front side at low speed in the house or the office, legs of a desk and the like is detected as the above described object to be avoided.

As described above, it is highly possible that the object to be avoided, with which the front wheels 10 or the fenders 32c may come into contact, appears in the area where the X direction angle a is close to 70 degrees within the detection area DA. That is to say, it is highly possible that the target to be avoided appears in an area close to the limit of the angle of field of view of the cameras 2R, 2L within the detection area DA. Difference between the positions of the front end side and the rear end side of the front wheels 10 in the vehicle width direction is small even when the front wheels 10 are in the toe-in state. However, in this embodiment, in the area where the X direction angle (azimuth angle) α is close to the limit of the field of view, the image processing unit 3 largely corrects the distances d which are obtained by the distance calculation portion 6d. By this, the target to be avoided with which the front wheels 10, which are in the toe-in state, may come into contact can accurately be detected.

The stereo cameras 90 are respectively attached at the corresponding control arms 43 by means of a stay (an attachment member) 94. The stay 94 has a fixing portion 94a which is fixed to a surface at the inside in the width direction of the control arm 43 by means of the bolt B, and an extending portion 94b extending toward the outside in the width direction from an end of the fixing portion 94a. The stay 94 is formed by bending a plate-like member. In one example, an angle formed between the fixing portion 94a and the extending portion 94b is equal to the angle R. By adopting this configuration, when the light axis LA of each of the lens units 4L, 4R is oriented toward the outside in a diagonal manner, it is easy to set the angle β which is formed between the light axis LA of each of the lens units 4L, 4R and the front-rear direction.

Also, the stereo cameras 90 may be arranged within the upper end portions of the control arms 43. For example, the stereo camera 1 is arranged within a hollow portion provided on the control arm 43. In this case, a transparent cover is attached at a front surface of the upper end portion of the control arms 43, and the pair of lens units 4L, 4R are arranged at a position which is located inside with respect to the cover. In this case also, the stereo cameras 1 can be arranged in order to achieve the same or the similar effect as described above.

Also, in one example, elongate holes 94c are provided at the fixing portion 94a, and the bolt B is inserted into each of the elongate holes 94c. The elongate hole 94c has an arc shape. In this case, by loosen the bolts B, it is possible to easily adjust the detection area DA of the stereo cameras 1 in the front-rear direction. And, the fixing portion 94a and the extending portion 94b may be connected by a bolt or the like through another member so that an angle between the fixing portion 94a and the extending portion 94b may be adjustable. In this case, the direction of the light axis LA of each of the lens units 4L, 4R of the stereo camera 1 can easily be adjusted so that the light axis LA is oriented in the vehicle width direction.

Moreover, as shown in FIG. 13, in this embodiment, the front side of the electric mobility vehicle is positioned within the detection area DA of the stereo cameras 1. For example, the front side of the head of the driver enters detection area DA of the stereo cameras 1. By this, it is also possible to grasp the relationship between the object to be avoided existing at the front side of the head of the driver and the head of the driver.

Here, this electric mobility vehicle can turn while moving forward at low speed. There may be a case where the electric mobility vehicle turns in a stopping state. In this case, a state in the vicinity of the driver is accurately detected by the stereo cameras 1.

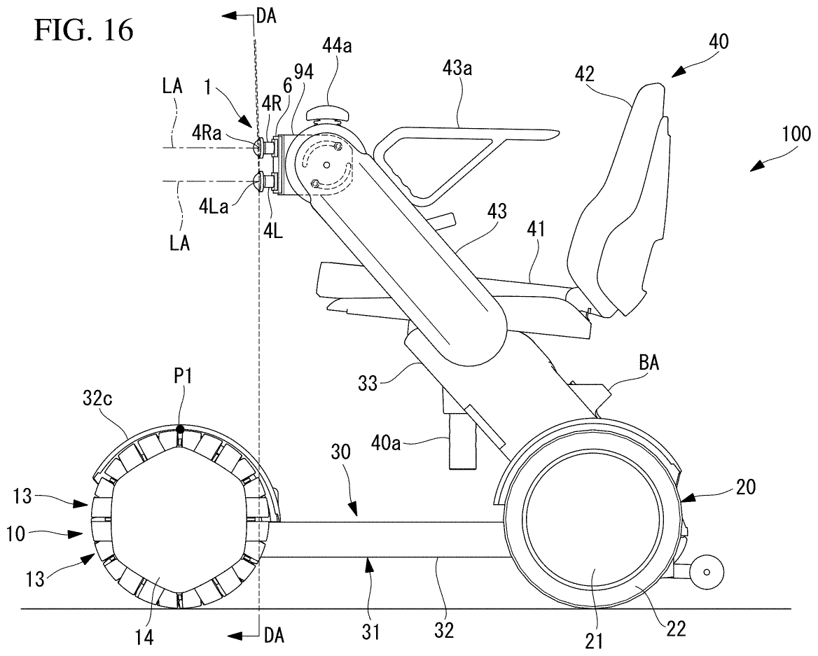

As shown in FIG. 16, in such a case where the angles of the field of view of the cameras 2R, 2L are about 180 degrees (±90) in the X direction angle (azimuth angle) α of the stereo camera 1, the detection area DA also exists at a position right in front of the driver. However, the detection area DA located right in front of the driver is an area where the angles of the field of view of the cameras 2R, 2L are about 180 degrees (±90).

However, in this embodiment, the image processing unit 3 largely corrects the distances d which are obtained by the distance calculation portion 6d in the area where the X direction angle (azimuth angle) α is closer to the limit of the field of view. By this, it is possible that the object to be avoided with which the driver comes into contact can accurately be detected within the detection area DA located right in front of the deriver.

In FIG. 16, the light axis LA of each of the stereo cameras 1 is directed in the horizontal direction, however, the light axis LA of each of the stereo cameras 1 may be directed in a diagonally downward direction or in a diagonally upward direction.

In this embodiment, the stereo camera 1 includes the distance correction portion 6e which corrects the calculated distances of a plurality of positions, which are calculated by the distance calculation portion 6d, on the basis of positions in an arrangement direction of the pair of lens units 4R, 4L, and in this correction, the closer it comes to the end portions of the detection area DA in the arrangement direction of the lens units 4R, 4L, the larger the reduction amount of the calculated distances becomes. As described above, the calculated distances are corrected at the end portions of the detection area DA in the arrangement direction of the lens units 4R, 4L, which is advantageous for accurately grasping the existence of the object to be avoided in the vicinity of the electric mobility vehicle.

Moreover, in this embodiment, one of the tip lenses (4Ra) of the pair of lens units 4R, 4L of the stereo camera 1 is located above with respect to the other one of the tip lenses (4La).

In addition, in this embodiment, the pair of lens units of the stereo camera are aligned in the vertical direction and/or the vehicle front-rear direction with each other.

The detection area DA capable of detecting the distances of an object is an area where the images obtained via one of the lens units 4R and the images obtained via the other one of the lens units 4L are overlapped with each other. This configuration, in which the pair of the lens units 4R, 4L are not aligned in the lateral direction, and one of the tip lenses 4Ra of the pair of lens units 4R, 4L is located above with respect to the other one of the tip lenses 4La, is advantageous for reducing the blind spot located at the outside in the width direction of the wheels, and the blind spot located at the outside in the width direction of the side surface and the like of the electric mobility vehicle 100.

Also, in this embodiment, one of the tip lenses 4Ra is located at the front side in the vehicle front-rear direction with respect to the other one of the tip lenses 4La.

With the above described configuration, it is possible to widen the detection area DA of the stereo camera 1 toward the rear side of the electric mobility vehicle 100 in such a state where the blind spot is reduced as described above. For example, when the other one of the pair of lens units 4R, 4L is located right under the one of the lens units 4R, 4L, the other one of the lens units 4L interferes the field of view located right under one of the lens units 4R. The above described configuration is advantageous for preventing the other one of the lens units 4L from interfering the field of view under one of the lens units 4R, or lowering the degree of the interference.

Also, in this embodiment, each of the light axes LA of the pair of lens units 4R, 4L extend in the diagonally downward direction.

With this configuration, in a state where each of the light axes LA of the pair of lens units 4R, 4L extend in the diagonally downward direction, it is also possible to accurately recognize existence of an object located at the vehicle front side.

Also, this embodiment includes a motor 50 which is provided in the mobility main body 30, and which drives the wheels 10, 20 or the other wheels, and a controller 80 which controls the motor 50, and the controller 80 detects the object to be avoided existing in the area where the azimuth angle is close to the limit of the detection area DA on the basis of the distances corrected by the distance correction portion 6e, and performs the avoidance operation which avoids the object to be avoided.

For example, in such a case where the lens units 4R, 4L are aligned in the vertical direction, and, in such a case where the pair of lens units 4R, 4L face the front side, the areas located at the outside in the width direction of the wheels 10, 20 of the electric mobility vehicle 100 are within the area where the azimuth angle is close to the limit of the detection area DA. In this configuration, the object to be avoided is accurately detected in the area where the azimuth angle is close to the limit of the detection area DA, which is advantageous for accurately grasping an object existing in the vicinity of the electric mobility vehicle 100.

Moreover, it is also possible that the azimuth angle corresponding to the limit of the detection area DA is a limit azimuth angle, and a position which is shifted by 15 degrees toward the side of the light axis LA of the stereo camera 1 from the limit azimuth angle is a limit proximate azimuth angle. In this case, the area where the azimuth angle is close to the limit of the detection area DA can be an area which is between the limit azimuth angle and the limit proximate azimuth angle.

In the stereo camera, distance d of an object is calculated by a following formula, as one example.

distance d=base length b×focal length f/parallax value θ

As described above, the base length b and the parallax value θ have an effect on the distance d which is calculated from the parallax value θ, however, in an area located close to a limite of an angle of a field of view, difference between the distance d, which is calculated on the basis of the base length b and the parallax value θ and etc., and an actual distance becomes extremely large. In technology disclosed in PTLs 1 and 2, as described above, it is possible to correct the distortion in each of the images of the pair of cameras, however, it is not possible to correct an error in distance which depends on a position in the arrangement direction.

The following aspects have been made considering the aforementioned circumstances, and a purpose of the following aspects is to provide a stereo camera and an electric mobility vehicle having the stereo camera capable of correcting errors of distances in an area located close to a limit of an angle of a field of view of a pair of cameras in an arrangement direction, and calculating accurate distances.

A first aspect is a stereo camera including: a pair of lens units; an imaging sensor obtaining a pair of images via the pair of lens units; a distance calculation unit which calculates distances of a plurality of positions within a detection area, which is an area where the pair of images are overlapped with each other, based on the pair of images; and a distance correction unit which applies correction to the calculated distances of the plurality of the positions, which are calculated by the distance calculation unit, wherein the correction corresponds to positions in an arrangement direction of the pair of lens units within the detection area, wherein the correction is one by which the closer the position comes close to an end portion in the arrangement direction within the detection area, the larger a reduction amount of the calculated distances by the correction becomes.

In this aspect, the pair of images obtained by the imaging sensors are images having a parallax which sees the detection area from a pair of points of view corresponding to the pair of lens units. The distance calculation unit calculates distance of each of positions within the detection area from the parallax of each of the positions within the detection area. With the calculated distances which are calculated by the distance calculation unit, errors which depend on a calculated position and the like in the arrangement direction of the pair of lens units occurs. The closer the position gets to a limit of the detection area in the arrangement direction, the smaller the parallax of the position becomes, and the larger the calculated distances become due to the error.

The distance correction unit corrects the calculated distances so as to be smaller in response to the position in the arrangement direction, and the calculated distances are corrected so that a reduction amount of the distances becomes larger as the position gets closer to an end portion of the detected area in the arrangement direction. Therefore, an effect due to the error is reduced, and an accurate distances can be calculated.

In the above described aspect, preferably, a distortion correction unit which corrects distortions in the pair of images is further provided, and the distance calculation unit calculates the distances from the pair of images which are corrected by the distortion correction unit.

In each of the pair of images, distortion caused by distortion of the lens of the lens unit occurs. The distortion in the pair of images is corrected by a distortion correction unit. Accordingly, by using the pair of images whose distortion is corrected, it is possible to calculate the distances of the positions within the detection area more accurately.

In the above described aspect, a storage unit which stores corrected data is further provided, and the corrected data includes a correction coefficient which corresponds to an azimuth angle, which is an angle with respect to light axis of the stereo camera in the arrangement direction, and the correction coefficient becomes smaller when the azimuth angle gets closer to a limit of the detection area of the stereo camera, and the distance correction unit multiplies the correction coefficients to the calculated distances which are calculated by the distance calculation unit.

With this configuration, by a simple calculation which only multiplies the correction coefficients to the calculated distances, which is calculated by the distance calculation unit, the calculated distances can suitably be corrected.

In the above described aspect, preferably, a change rate of the correction coefficients with respect to the azimuth angle become larger as the azimuth angle gets closer to the limit of the detection area.

Differences between the calculated distances, which are calculated by the distance calculation unit, and the actual distances become larger at much larger increase rate, as the azimuth angle gets closer to the limit of the detection area. According to the above described configuration, it is possible to correct the distances more accurately by using the correction coefficient.

With the above described aspect, preferably, the correction coefficient is equal to or smaller than 0.6 in the detection area where the azimuth angle is equal to or more than 65 degrees.

As described above, the error in the calculated distances become larger at the end portion in the arrangement direction within the detection area where the magnitude of the azimuth angle (an absolute value) becomes larger. In order to correct large error in the calculated distances at the end portion within the detection area with a high precision, it is preferable that the correction coefficient meets the above condition.

In the above described embodiment, preferably, each of angles of a field of view of the pair of lens units in the arrangement direction are equal to or more than 140 degrees.

The correction of the distances by using the distance correction unit is extremely advantageous for calculating the distances from the pair of images which are obtained by using a wide angle lens unit.

A second aspect is an electric mobility vehicle having a mobility main body, wheels which support the mobility main body, and the stereo cameras which are attached to the mobility main body according to any of the above.

According to this aspect, the stereo cameras detect distances with respect to an object exists in the vicinity of the mobility main body within the detection area. Accordingly, on the basis of the distances detected by the stereo cameras, it is possible to grasp an existence of an object to be avoided within the detection area. The object to be avoided is, for example, a person, an obstacle, a wall, a gutter, furniture, and the like.

Also, the stereo camera includes a distance correction unit which corrects the calculated distances of the plurality of positions, which are calculated by the distance calculation unit, in response to the positions of the pair of lens units in the arrangement direction, with regard to the correction, the closer the calculated distances get to the end portion of the lens units in the arrangement direction within the detection area, the larger the reduction amount of the calculated distances become. As described above, the calculated distances are corrected in the end portion of the lens units in the arrangement direction within the detection area, which is advantageous for accurately grasping the existence of the object to be avoided in the vicinity of the electric mobility.

In the second aspect, preferably, one of tip lenses of the pair of lens units of the stereo camera is arranged above with respect to the other one of the tip lenses.

The detection area capable of detecting the distances of the object is an area where the images obtained via one of the lens units and the images obtained via the other one of the lens units are overlapped with each other. The pair of lens units are not aligned in the horizontal direction, but the configuration in which one of the tip lenses of the pair of lens units is arranged above with respect to the other one of tip lenses is advantageous for reducing a blind spot located at the outside in the width direction of the wheels, and, a blind spot located at the outside in the width direction of a side surface and the like of the electric mobility vehicle.

In the above aspect, preferably, one of the tip lenses is located at the front side in the vehicle front-rear direction with respect to the other one of the tip lenses.

With this configuration, it is possible to widen the detection area of the stereo camera toward the rear side of the electric mobility vehicle in a state where the blind spot is reduced as described above. For example, when the other one of the pair of lens units is arranged right under one of the pair of lens units, the other one of the lens units interferes the field of view located right under one of the lens units. The above described configuration is advantageous for preventing the other one of the lens units from interfering the field of view located under one of the lens units or lowering the degree of the interference.

In the second aspect, preferably, each of the light axes of the pair of lens units extend in the diagonally downward direction.

This configuration is advantageous for accurately recognizing an object existing in an area located at the outside in the width direction of the electric mobility vehicle, in an area located at the outside in the width direction of the wheels, and the like.

In the above described aspect, preferably, each of the pair of lens units of the stereo camera face the vehicle front direction.

This configuration is capable of accurately recognizing the object existing in the vehicle front direction in a state where each of the light axes of the pair of lens units extend in the diagonally downward direction.

In the second aspect, preferably, the pair of lens units of the stereo camera are arranged in the vertical direction and/or the vehicle front-rear direction with each other.

The detection area where the distance of the object can be detected is an area where the images obtained via one of the lens units and the images obtained via the other one of the lens units are overlapped with each other. The pair of lens units are not arranged in the lateral direction, however, the configuration in which the pair of lens units are arranged in the vertical direction and/or the vehicle front-rear direction with each other is advantageous for reducing the blind spot located at the outside in the width direction of the wheels, and the blind spot located at the outside in the width direction of the side surface and the like of the electric mobility vehicle.

In the second aspect, preferably, the stereo camera is attached to arm rests or control arms of the mobility main body, and the arm rests and the control arms are ones on which a driver places at least one of arms or hands thereof.

The driver can visually confirm positions of the hands and the positions of the arms easily. Also, even in a case where the driver is not looking at the positions of own hands and the positions of own arms, it is possible to instinctively recognize the approximate positions of own hands and the approximate positions of own arms. Therefore, the configuration of this embodiment, in which the stereo camera is provided on the control arms and the arm rests, is advantageous for preventing the stereo cameras from having a collision with a wall and the like.

In the second aspect, preferably, two of the stereo cameras are attached to the mobility main body so as to be symmetrical in a left-and-right direction.

Whether or not the object to be avoided exists in an area located at the outside in the width direction of both of the left and right wheels is monitored by the two stereo cameras. It is difficult for the driver to certainly grasp all of the objects to be avoided existing at both left and right sides by visual confirmation, therefore, the above described configuration is extremely useful in a house and an office.

In the second aspect, preferably, the wheels are front wheels, and the detection area of the stereo camera includes an area located at the outside in the vehicle width direction of the front wheels.

With this configuration, it is possible to grasp the object to be avoided existing in the vicinity of the front wheels.

In the second aspect, preferably, the electric mobility vehicle further includes a motor which drives the front wheels or the other wheels, and which is provided in the mobility main body, and the control unit detects the object to be avoided existing in an area whose azimuth angle corresponding to the arrangement direction, is close to the limit of the detection area in response to the distances corrected by the distance correction unit, and performs avoidance operation for avoiding the object to be avoided.

For example, the pair of lens units are arranged in the vertical direction, and when the pair of lens units face the front direction, the area located at the outside in the width direction of the wheels of the electric mobility vehicle enters the area where the azimuth angle is close to the limit of the detection area. With this configuration, the object to be avoided is accurately detected in the area where the azimuth angle is close to the limit of the detection area, which is advantageous for accurately grasping the object existing in the vicinity of the electric mobility vehicle.

In the second aspect, preferably, the area whose azimuth angle is close to the limit of the detection area is an area between a limit azimuth angle corresponding to the limit of the detection area and a close angle to the limit azimuth angle which is 15 degrees away toward the light axis side of the stereo camera from the limit azimuth angle.

In the second aspect, preferably, the electric mobility vehicle is one on which one person sits to ride.

According to the aforementioned aspects, it is possible to achieve such an effect that error of distances in an area located close to a limit of an angle of a field of view of a pair of cameras in the arrangement direction can be corrected so as to calculate accurate distances.

### REFERENCE SIGNS LIST

1 stereo camera
2R, 2L camera
3 image processing unit
4R, 4L lens unit
5R, 5L imaging sensor
6a distortion correction portion
6b deviation correction portion
6c parallax image creation portion
6d distance calculation portion
6e distance correction portion
6f three-dimensional image creation portion
10 front wheel (wheel)
11 axle (wheel)
12 suspension
13 roller
14 hub
20 rear wheel
30 mobility main body
31 body
32 base portion
33 seat support portion
40 seat unit
43 control arm
43a arm rest
44 operation portion
44a operation lever
45 setting portion
46 notification device
50 motor
60 control unit
70 motor driver
80 controller
81 control section
82 memory
82a travel control program
100 electric mobility vehicle
DA detection area
LA light axis of stereo camera
α, βX direction angle (azimuth angle)
θ parallax

1. A stereo camera comprising:
a pair of lens units;
an imaging sensor obtaining a pair of images via the pair of lens units; and
a processor, the processor is configured to conduct:
a distance calculation process which calculates distances of a plurality of positions within a detection area, which is an area where the pair of images are overlapped with each other, based on the pair of images; and
a distance correction process which applies correction to the calculated distances of the plurality of the positions, which are calculated by the distance calculation process, wherein the correction corresponds to positions in an arrangement direction of the pair of lens units within the detection area, wherein
the correction is one by which the closer the position comes close to an end portion in the arrangement direction within the detection area, the larger a reduction amount of the calculated distances by the correction becomes.

2. The stereo camera according to claim 1 wherein
the processor is further configured to conduct a distortion correction process which corrects distortion in the pair of images, respectively, and,
the distance calculation process calculates the distances from the pair of images corrected by the distortion correction process.

3. The stereo camera according to claim 1, wherein
the stereo camera comprises a memory which stores correction data, and,
the correction data includes correction coefficients which correspond to an azimuth angle, which is an angle with respect to light axis of the stereo camera, in a arrangement direction, the correction coefficients becomes smaller when the azimuth angle comes closer to a limit of the detection area of the stereo camera, and the distance correction process multiplies the correction coefficients to the calculated distances which are calculated by the distance calculation process.

4. The stereo camera according to claim 3, wherein a change rate of the correction coefficients with respect to the azimuth angle become larger as the azimuth angle comes closer to the limit of the detection area.

5. The stereo camera according to claim 1, wherein each of angles of view of the pair of lens units in the arrangement direction is equal to or more than 140 degrees.

6. The stereo camera according to claim 3, wherein the correction coefficient is equal to or smaller than 0.6 in an area where the azimuth angle is equal to or more than 65 degrees.

7. An electric mobility vehicle comprising:
a mobility main body;
a wheel which supports the mobility main body; and
the stereo camera which is attached to the mobility main body according to claim 1.

8. The electric mobility vehicle according to claim 7, wherein one of tip lenses of the pair of lens units of the stereo camera is arranged above with respect to the other one of the tip lenses.

9. The electric mobility vehicle according to claim 8, wherein one of the tip lenses is located at a front side in a vehicle front-rear direction with respect to the other one of the tip lenses.

10. The electric mobility vehicle according to claim 7, wherein light axes of the pair of lens units respectively extend in a diagonally downward direction, or respectively extended in a diagonally downward and a diagonally outward direction.

11. The electric mobility according to claim 10, wherein each of the pair of lens units of the stereo camera face the vehicle front direction.

12. The electric mobility vehicle according to claim 7, wherein the pair of lens units of the stereo camera are arranged in a vertical direction and/or a vehicle front-rear direction with each other.

13. The electric mobility vehicle according to claim 7, wherein the stereo camera is attached to an arm rest or a control arm of the mobility main body, and the arm rest and the control arm are ones on which a driver places at least one of an arm or a hand thereof.

14. The electric mobility vehicle according to claim 7, wherein two of the stereo cameras are attached to the mobility main body so as to be symmetrical in a left-and-right direction.

15. The electric mobility vehicle according to claim 11, wherein the wheel is a front wheel, and
the detection area of the stereo camera includes an area located at an outside in a vehicle width direction of the front wheel.

16. The electric mobility vehicle according to claim 7, wherein
the wheel is an omnidirectional front wheel, and
the detection area of the stereo camera includes an area of a travel surface, the area being located at a vicinity of the wheel and at an outside in a vehicle width direction of the wheel.

17. The electric mobility vehicle according to claim 7, wherein the electric mobility vehicle is one on which one person sits to ride.
